(19) United States
(12) Patent Application Publication
(10) Pub. No.: US 2026/0303975 A1
(43) Pub. Date: Oct. 1, 2026

(54) TRAVELING DEVICE, METHOD FOR CONTROLLING TRAVELING DEVICE, AND NON-TRANSITORY RECORDING MEDIUM

(71) Applicants: Jumpei AOYAMA, Kanagawa (JP); Susumu MINAGI, Kanagawa (JP)

(72) Inventors: Jumpei AOYAMA, Kanagawa (JP); Susumu MINAGI, Kanagawa (JP)

(21) Appl. No.: 19/567,285

(22) Filed: Mar. 16, 2026

(30) Foreign Application Priority Data
Mar. 18, 2025 (JP) 2025-043141

(51) Int. Cl. H04N 23/695; G06T 7/73; H04N 23/69

(52) U.S. Cl. CPC H04N 23/695; G06T 7/74; H04N 23/69; G06T 2207/30204; G06T 2207/30244

(57) ABSTRACT

A traveling apparatus includes a mover including a crawler traveling body to rotate a crawler to autonomously travel, an imaging device above the mover, a drive source in the imaging device to move an imaging direction, a marker having an alignment mark, and processing circuitry. The circuitry stores, as a preset position, an angle of the imaging device adjusted so that the mark in a captured image of the marker captured by the imaging device is placed at a center, detects a position of the mark in another captured image of the marker captured by the imaging device during autonomous traveling, calculates a deviation of the detected position of the mark from a center position to detect a deviation amount of the imaging direction with respect to the preset position, and drives the drive source based on the deviation amount to correct the imaging direction with respect to the mark.

### CROSS-REFERENCE TO RELATED APPLICATION

This patent application is based on and claims priority pursuant to 35 U.S.C. § 119(a) to Japanese Patent Application No. 2025-043141, filed on Mar. 18, 2025, in the Japan Patent Office, the entire disclosure of which is hereby incorporated by reference herein.

### BACKGROUND

### Technical Field

The present disclosure relates to a traveling apparatus, a method for controlling the traveling apparatus, and a non-transitory recording medium.

### Related Art

Techniques have been proposed for controlling the vibration and impact caused by movement of a traveling apparatus in accordance with information from an imaging device such as a camera attached to the traveling apparatus.

For example, a technique has been proposed for determining whether it is necessary to adjust a movable camera that may cause an imaging-direction deviation in which the position of the imaging direction moves periodically or irregularly during autonomous traveling or stopping of a traveling apparatus.

### SUMMARY

The present disclosure described herein provides a traveling apparatus that includes a mover, an imaging device, a drive source, a marker, and processing circuitry. The mover includes a crawler traveling body to rotate a crawler to autonomously travel. The imaging device is above the mover. The drive source is in the imaging device to move an imaging direction of the imaging device. The marker has an alignment mark for aligning a position of the imaging device. The processing circuitry stores, as a preset position, an angle of the imaging device adjusted so that the alignment mark included in a captured image of the marker captured by the imaging device is placed at a center of the captured image, detects a position of the alignment mark included in another captured image of the marker captured by the imaging device during autonomous traveling, calculates a deviation of the detected position of the alignment mark from a center position of the other captured image to detect a deviation amount of the imaging direction of the imaging device with respect to the preset position, and drive the drive source based on the deviation amount of the imaging direction of the imaging device to correct the imaging direction of the imaging device with respect to the alignment mark.

The present disclosure described herein also provides a method of controlling a traveling apparatus. The method includes adjusting, storing, detecting, calculating, and driving. The adjusting adjusts an angle of an imaging device of the traveling apparatus so that, in a captured image of a marker of the traveling apparatus captured by the imaging device, an alignment mark of the marker is positioned at a center of the captured image. The storing stores, as a preset position, the angle of the imaging device. The detecting detects a position of the alignment mark included in another captured image of the marker captured by the imaging device during autonomous traveling of the traveling apparatus. The calculating calculates a deviation of the detected position of the alignment mark from a center position of said another captured image to detect a deviation amount of an imaging direction of the imaging device with respect to the preset position. The driving drives a drive source of the traveling apparatus based on the deviation amount of the imaging direction of the imaging device to correct the imaging direction of the imaging device with respect to the alignment mark.

The present disclosure described herein also provides a non-transitory recording medium storing computer-readable instructions which, when executed by one or more processors, cause the one or more processors to perform a process of controlling a traveling apparatus. The process includes adjusting, storing, detecting, calculating, and driving. The adjusting adjusts an angle of an imaging device of the traveling apparatus so that, in a captured image of a marker of the traveling apparatus captured by the imaging device, an alignment mark of the marker is positioned at a center of the captured image. The storing stores, as a preset position, the angle of the imaging device. The detecting detects a position of the alignment mark included in another captured image of the marker captured by the imaging device during autonomous traveling of the traveling apparatus. The calculating calculates a deviation of the detected position of the alignment mark from a center position of said another captured image to detect a deviation amount of an imaging direction of the imaging device with respect to the preset position. The driving drives a drive source of the traveling apparatus based on the deviation amount of the imaging direction of the imaging device to correct the imaging direction of the imaging device with respect to the alignment mark.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a configuration of a traveling apparatus;

FIGS. 2A, 2B, and 2C are diagrams illustrating a configuration of a camera;

FIG. 3 is a diagram illustrating a marker;

FIG. 4 is a diagram illustrating a captured image of a mark set at a home position;

FIG. 5 is a block diagram illustrating a hardware configuration of a traveling apparatus;

FIG. 6 is a flowchart of a process of restoring the position of the camera during autonomous travel by a traveling apparatus;

FIG. 7 is a diagram illustrating an image when the amount of imaging-direction deviation of a camera is not greater than a specified value; and

FIG. 8 is a diagram illustrating an image when the amount of imaging-direction deviation of a camera is greater than a specified value.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In the following description, embodiments of a traveling apparatus, a method for controlling the traveling apparatus, and a recording medium storing program code are described in detail with reference to the accompanying drawings.

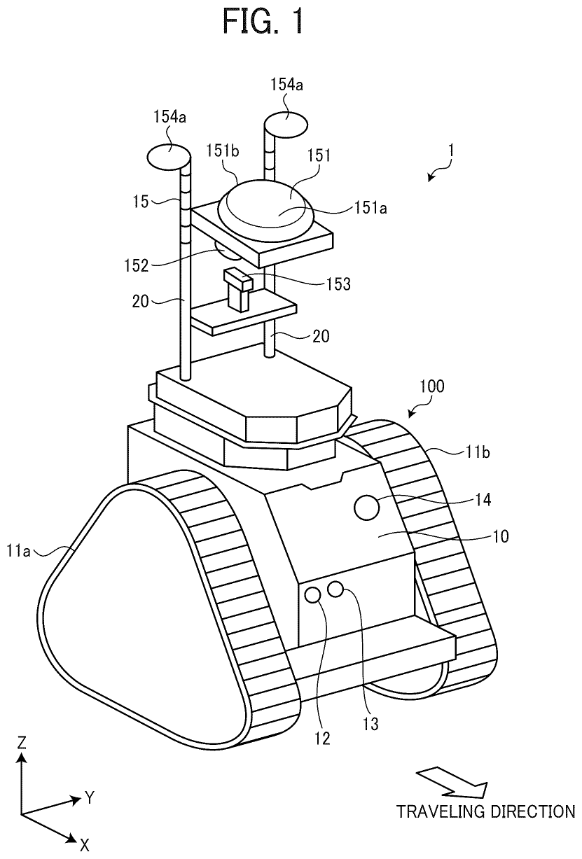

FIG. 1 is a perspective view of a traveling apparatus 1 and illustrates an example of the configuration of the traveling apparatus 1.

In the present specification, a Y-direction, which is indicated by arrow Y in FIG. 1, indicates the lateral direction of the traveling apparatus 1. An X-direction, which is indicated by arrow X in FIG. 1, indicates a traveling direction or an advancing direction of the traveling apparatus 1. A Z-direction, which is indicated by arrow Z in FIG. 1, indicates a height direction of the traveling apparatus 1.

The traveling apparatus 1 includes a crawler traveling body 11a, a crawler traveling body 11b, and a main body 10. The crawler traveling body 11a, the crawler traveling body 11b, and the main body 10 constitute at least part of a mover 100.

The crawler traveling bodies 11a and 11b are an example of units serving as driving members of the traveling apparatus 1. The crawler traveling bodies 11a and 11b are crawler-type traveling bodies using metallic or rubber belts.

The crawler traveling bodies 11a and 11b have a larger ground contact area than a mover such as an automobile that travels with tires, and travel stably even in environments with, for example, poor footing. While a mover that travels with tires requires a turning space in performing a rotating operation, the traveling apparatus 1 including the crawler traveling bodies 11a and 11b performs so-called neutral turn (turn with a center point between two crawler traveling bodies as a pivot point) or pivot turn (turn with one crawler traveling body as a center point). Thus, the traveling apparatus 1 smoothly performs a rotating operation even in a limited space. The traveling apparatus 1 is not limited to an apparatus that performs both the neutral turn and the pivot turn, and may be an apparatus that performs at least one of the pivot turn or the pivot turn. The neutral turn and the pivot turn are examples of turning operations.

The term “neutral turn” indicates that the traveling apparatus 1 rotates right and left crawler belts at a constant speed in opposite directions to turn on the spot with the center of the traveling apparatus 1 as an axis. Such a turning method is also referred to as spin turn. The pivotal turn indicates that the traveling apparatus 1 stops one of the crawler belts and rotates only the other crawler belt to turn with the stopped crawler belt as an axis. Such a turning method is also referred to as pivoting.

The two crawler traveling bodies 11a and 11b are installed such that the traveling apparatus 1 can travel with the main body 10 interposed between the two crawler traveling bodies 11a and 11b. The number of the crawler traveling bodies is not limited to two, and may be three or more. For example, the traveling apparatus 1 may be provided with three crawler traveling bodies such that the traveling apparatus 1 can travel with the three crawler traveling bodies aligned in three rows in parallel. Further, for example, the traveling apparatus 1 may have four crawler traveling bodies arranged in the front-rear and left-right directions like tires of an automobile.

The crawler traveling bodies 11a and 11b, which may be referred to collectively as crawler traveling body 11 in the following description, have a substantially triangular shape. According to the crawler traveling body 11 having a substantially triangular shape, for example, when there is a constraint on the size in the front-rear direction, the ground contact area can be increased within the limited size in the front-rear direction. Such a configuration can enhance the stability during operation as described above. On the other hand, in a case where there is a constraint on the size in the front-rear direction, a so-called tank-type crawler belt in which the upper side (drive wheel side) is longer than the lower side (track wheel side) has a small ground contact area as a whole and becomes unstable. As described above, the crawler traveling body 11 is effective in enhancing the traveling performance of the traveling apparatus 1 that is relatively small in size.

The main body 10 is a support body that supports the crawler traveling bodies 11a and 11b in a travelable state, and is a control device that performs control for driving the traveling apparatus 1. The main body 10 is also mounted with a battery that supplies electric power for driving the crawler traveling bodies 11a and 11b.

The main body 10 of the traveling apparatus 1 includes a power button 12, a start button 13, an emergency stop button 14, a state display lamp 15, and a support column 20.

The power button 12 is an operation unit that is pressed by a person around the traveling apparatus 1 to turn on or off the power of the traveling apparatus 1. The start button 13 is an operation unit that is pressed by a person around the traveling apparatus 1 to start the two crawler traveling bodies 11a and 11b. The emergency stop button 14 is an operation unit that is pressed by a person around the traveling apparatus 1 to stop the traveling apparatus 1 during traveling.

The state display lamp 15 is provided with the support column 20. The state display lamp 15 is a notifier for notifying the state of the traveling apparatus 1. For example, when the state change of the traveling apparatus 1 such as a decrease in the remaining amount of the battery occurs, the state display lamp 15 is turned on to notify surrounding people of the state change of the traveling apparatus 1. The state display lamp 15 is turned on when there is a possibility of occurrence of an abnormality, for example, when the presence of an object that hinders the traveling of the traveling apparatus 1 is detected.

FIG. 1 illustrates an example in which the traveling apparatus 1 includes one state display lamp 15. However, the number of state display lamps 15 may be two or more. The notifier may be configured to notify the state of the traveling apparatus 1 not only by the state display lamp 15 but also by, for example, an alert sound emitted from a speaker.

The traveling apparatus 1 includes a distance measuring sensor 152 for horizontal detection. The distance measuring sensor 152 is installed at a position of height of 0.5 m with the traveling direction of the main body 10 as the front. The distance measuring sensor 152 for horizontal detection performs, for example, detection by laser light and distance measurement in a two dimensional direction. The distance measuring sensor 152 is, for example, a laser range finder (LRF) or a two-dimensional light detection and ranging (2D-LiDAR) sensor. Examples of the 2D-LiDAR sensor include, but not limited to, a micro electro mechanical systems (MEMs) sensor and a rotating mirror sensor.

The distance measuring sensor 152 irradiates an object with laser light and measures a distance to the object and a direction in which the object is present, based on a measurement result of a time period from when the laser light hits the object to when the laser light is reflected. The distance measuring sensor 152 measures the direction in a range of 270 degrees around the forward X direction. The traveling apparatus 1 measures the distance to an object in a wide range in the horizontal direction using the distance measuring sensor 152, and uses the distance as obstacle information.

The traveling apparatus 1 also includes a distance measuring sensor 153 for oblique detection. The distance measuring sensor 153 is installed at a height of 0.9 m and a depression angle of 30 degrees with the traveling direction of the main body 10 as the front. This installation position is determined so that the surface of a traveling road up to the front side of the traveling apparatus 1 can be detected. The distance measuring sensor 153 for oblique detection is, for example, an LRF or a three-dimensional (3D) LiDAR that measures a distance in a three-dimensional direction. Examples of the three-dimensional distance measuring sensor of the 3D-LiDAR type include, but not limited to, a MEMs type and a rotating mirror type.

The 3D-LiDAR is of a non-repetitive scanning type that measures a range of 70.4 degrees of a conical shape as viewed from the center of the detection surface of the sensor and measures distances up to 90 m. The non-repetitive scanning type performs scanning so as to draw a flower while shifting the phase little by little in the horizontal direction and the vertical direction, and has a feature that the point cloud coverage within the measurement range increases due to accumulation of time. The distance measuring sensor 153 is attached at an angle below the horizontal so as to be directed obliquely downward at a predetermined inclination angle with respect to the horizontal traveling road surface.

The distance measuring sensor 153 irradiates an object such as a road surface obstacle with laser light, measures a distance to the object and a direction in which the object is present based on a measurement result of a time until the laser light hits the object and is reflected, and acquires the measurement result as data. Regarding the installation position of the distance measuring sensor 153, an appropriate value is determined based on the width and length of the crawler belts of the crawler traveling bodies 11a and 11b and the size, width, depth, and height of the object to be detected.

In addition, the traveling apparatus 1 includes a camera 151 with the traveling direction of the main body 10 as the front. The camera 151 includes an imaging device 151a such as an omnidirectional camera, a stereo camera, and an infrared ray camera. As illustrated in FIG. 1, the camera 151 is located above the main body 10 of the traveling apparatus 1, and is attached to an upper portion of the main body 10 at a position away from the main body 10 via the support columns 20.

The camera 151 may be attached on the main body 10 without any gap. In such a case, however, the camera would be located at a low position for the purpose of observation at the height of the human eye line. Consequently, the camera may not be able to perform the observation that a human can perform. In order to bring the camera 151 as close as possible to the human eye line, the camera 151 is attached to an upper portion via the support columns 20. However, when the camera 151 being a heavy object is raised upward, the center of gravity of the entire traveling apparatus 1 is moved upward, which hinders the stability. For this reason, it is preferable to balance the camera 151 in the front-rear direction with respect to the portions related to traveling or processing such as the main body 10 and the crawler traveling bodies 11a and 11b. In other words, the camera 151 is devised so that the center of gravity is located at the center in the front-rear direction, thus ensuring the stability.

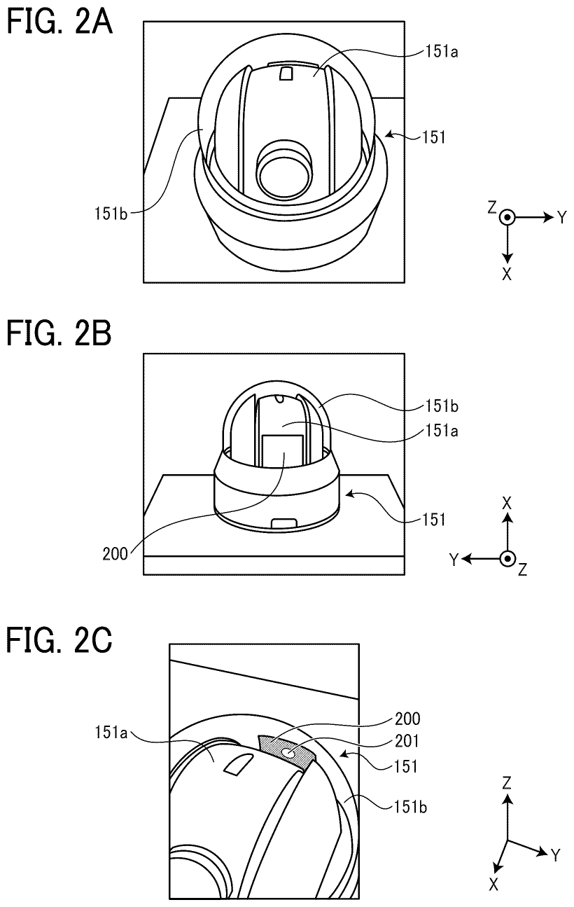

FIGS. 2A, 2B, and 2C are diagrams illustrating a configuration of the camera 151. FIG. 2A is a front view of the camera 151 as viewed from the front in the traveling direction (i.e., X direction). FIG. 2B is a rear view of the camera 151 as viewed from the rear in the traveling direction (i.e., X direction). FIG. 2C is a view of the camera 151 as viewed from above toward the rear in the traveling direction (i.e., X direction). As illustrated in FIGS. 2A, 2B, and 2C, the camera 151 includes an imaging device 151a inside a transparent dome 151b having a hemispherical shape.

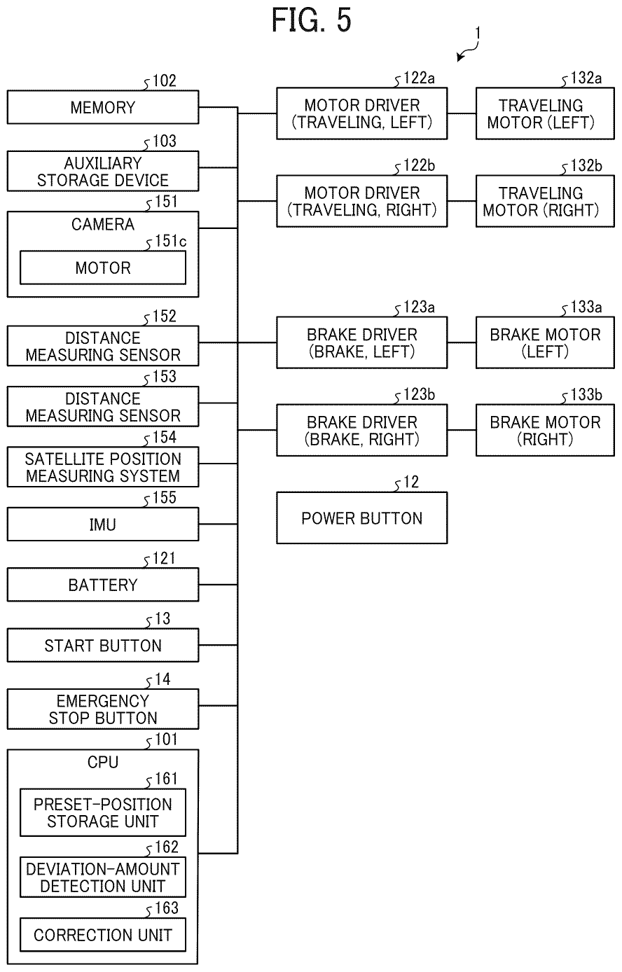

The imaging device 151a of the camera 151 includes a pan-tilt-zoom (PTZ) or an optical zooming mechanism that changes an imaging direction. In other words, the imaging device 151a of the camera 151 includes a drive source (e.g., a motor) 151c (see FIG. 5) for driving a pan-tilt (PT) mechanism that changes the imaging direction. The imaging device 151a having the PTZ mechanism captures an image on the entire surface of the hemisphere.

In a traveling apparatus including an imaging device, if an unintended movement (due to vibration or impact) occurs, an image may be captured in a state of imaging-direction deviation in which the imaging direction of the imaging device is deviated by the unintended movement.

To deal with such a situation, it may be determined whether to adjust a movable camera (an example of an imaging device) that may cause an imaging-direction deviation in which the position of an imaging direction is deviated, periodically or irregularly, during autonomous traveling or stopping of a traveling apparatus. In such a case, for example, it is conceivable to prepare a fixed camera different from a movable camera to be adjusted, and to capture an image on a space including a predetermined target object present at a specific place by both the movable camera (an example of an imaging device) and the fixed camera. In such a case, however, the adjustment of the imaging-direction deviation of the movable camera may not be performed anytime and anywhere, and it may take time and effort to adjust the movable camera.

In this regard, as illustrated in FIGS. 2B and 2C, the traveling apparatus 1 has a marker 200 behind the imaging device 151a of the camera 151 mounted on the traveling apparatus 1. In other words, the marker 200 is at the back side of the imaging device 151a that is a side other than the front side, which is the front side in the traveling direction of the mover 100, the lateral sides, and the upper side of the imaging device 151a. The imaging device 151a of the camera 151 captures an image on the marker 200 to detect the imaging-direction deviation of the imaging device 151a.

For example, as illustrated in FIGS. 2B and 2C, the camera 151 includes the marker 200 for detecting the imaging-direction deviation inside the dome 151b. The camera 151 is installed in an upper portion away from the center of gravity, which is likely to receive vibration or impact, and it is preferable to install the marker 200 in the dome 151b. The marker 200 is not limited to being installed in the dome 151b, and may be installed in a housing or a support column of the traveling apparatus 1.

The marker 200 is installed on a side not used for imaging during autonomous traveling, that is, behind the imaging device 151a of the camera 151 mounted on the traveling apparatus 1. In other words, the marker 200 is at the back side of the imaging device 151a that is a side other than the front side, which is the front side in the traveling direction of the mover 100, the lateral sides, and the upper side of the imaging device 151a. Such effective use of the back side of the imaging device 151a that is not used for imaging during autonomous traveling can prevent the imaging during autonomous traveling from being affected.

As described above, the imaging device 151a having the PTZ mechanism captures an image of the entire surface of the hemisphere. Accordingly, the back side of the imaging device 151a (i.e., the side other than the front side, which is the front side in the traveling direction of the mover 100, the lateral sides, and the upper side) that is not used for imaging during autonomous traveling can be effectively utilized.

The marker 200 is in a sheet shape that can be attached to the inside of the dome 151b, and is installed in the dome 151b by attachment. The marker 200 includes a sheet having weather resistance. The sheet is made of a material that is less likely to undergo deterioration such as deformation, discoloration, and deterioration due to direct sunlight, high temperature, or low temperature when the sheet is used outdoors.

The marker 200 is described below in detail.

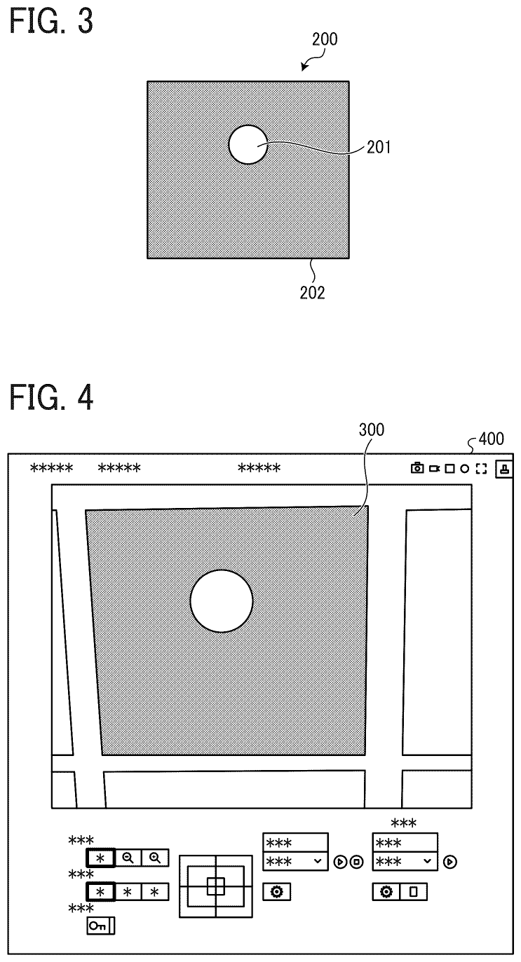

FIG. 3 is a diagram illustrating an example of the marker 200. As illustrated in FIG. 3, the mark 201 formed on the marker 200 has a round shape. The mark 201 has a white tone color. A base 202 around the mark 201 has a black tone color. Thus, the contrast between the mark 201 and the base 202 is clear.

The marker 200 has such a size that the mark 201 formed on the marker 200 is included in the imaging angle of view of the imaging device 151a of the camera 151 and the center position of the marker 200 can be determined by viewing the entire captured image. The determination of the center position of the marker 200 can be performed by image processing.

Using the marker 200 described above allows the process to be completed within the dome 151b of the camera 151, and the environment resistance can be obtained. The mark 201 formed on the marker 200 has a round shape and a white toner color. Thus, the mark 201 can be determined even if the mark 201 is out of focus.

A description is given below of the initial setting of the camera 151.

After the work of attaching the marker 200 to the inside of the dome 151b is performed by a user, the home position of the imaging device 151a of the camera 151 is set by the user so that the mark 201 of the marker 200 be aligned with the position corresponding to the center of a captured image. The home position is an origin for defining the absolute position of the camera 151.

The traveling apparatus 1 can be connected to a network such as the Internet. After a user performs fine adjustment using, e.g., a personal computer by an editing function (e.g., a graphical user interface (GUI) for setting on a website) of the camera 151, the captured image of the mark 201 at the home position can be stored (preset) in advance.

FIG. 4 is a diagram illustrating an example of a captured image of the mark 201 set at the home position. In the example illustrated in FIG. 4, in a captured image 300 of the mark 201 displayed in a GUI 400 for setting on a website, the marker 200 including the mark 201 is aligned with the position corresponding to the center of the captured image 300 as a home position in the imaging device 151a.

After the marker 200 including the mark 201 is placed at the predetermined position (home position) as described above, the traveling apparatus 1 captures an image of the mark 201 at the back side (i.e., the side other than the front side, which is the front side in the traveling direction of the mover 100, the lateral sides, and the upper side) of the traveling apparatus 1 with the imaging device 151a, thus allowing detection of the amount of imaging-direction deviation of the imaging device 151a.

A description is given below of a hardware configuration of the traveling apparatus 1. FIG. 5 is a block diagram illustrating an example of a hardware configuration of the traveling apparatus 1.

As illustrated in FIG. 5, the traveling apparatus 1 includes a central processing unit (CPU) 101, a memory 102, an auxiliary storage device 103, a camera 151, a distance measuring sensor 152, a distance measuring sensor 153, a satellite positioning system 154, an inertial measurement unit (IMU) 155, a battery 121, a motor driver 122a, a motor driver 122b, a traveling motor 132a, a traveling motor 132b, a brake driver 123a, a brake driver 123b, a brake motor 133a, a brake motor 133b, a power button 12, a start button 13, and an emergency stop button 14.

The CPU 101 controls the entire traveling apparatus 1. The memory 102 is a temporary storage area for executing programs by the CPU 101. The auxiliary storage device 103 stores programs executed by the CPU 101.

The CPU 101 operates according to a program stored in the memory 102, and thus causes the traveling apparatus 1 to autonomously travel using an obstacle map. The CPU 101 operates according to a program stored in the memory 102, and thus functions as a preset-position storage unit 161, a deviation-amount detection unit 162, and a correction unit 163.

The preset-position storage unit 161 stores, as a preset position in the auxiliary storage device 103, the angle of the imaging device 151a adjusted so that the mark 201 included in the captured image (see FIG. 4) of the marker 200 captured by the imaging device 151a is located at the center. The preset position (i.e., angle) to be stored is a relative position (i.e., angle) from the home position (i.e., initial position).

The deviation-amount detection unit 162 detects the position of the mark 201 included in the captured image of the marker 200 captured by the imaging device 151a during autonomous traveling, calculates the deviation of the detected position of the mark 201 from the center position, and detects the deviation amount of the imaging direction of the imaging device 151a with respect to the preset position (i.e., angle).

The correction unit 163 corrects the imaging direction of the imaging device 151a with respect to the marker 200 including the mark 201 by driving the drive source (e.g., motor) 151c based on the shift amount of the imaging direction of the imaging device 151a detected by the deviation-amount detection unit 162.

Programs executed by the traveling apparatus 1 are recorded and provided in a computer-readable recording medium, such as a compact disc-read-only memory (CD-ROM), a flexible disk (FD), a compact disc-recordable (CD-R), or a digital versatile disc (DVD), in a file in installable or executable format.

Programs executed by the traveling apparatus 1 may be stored in a computer connected to a network such as the Internet and provided by being downloaded via the network. Programs executed by the traveling apparatus 1 may be provided or distributed via a network such as the Internet. Programs executed on the traveling apparatus 1 may be provided by being incorporated in advance in, for example, the ROM.

The motor drivers 122a and 122b are drivers for the traveling motors 132a and 132b disposed in the two crawler traveling bodies 11a and 11b, respectively. The motor drivers 122a and 122b may be referred to collectively as motor driver(s) 122 unless distinguished in the following description. In the following description, likewise, the traveling motors 132a and 132b may be referred to collectively as traveling motor(s) 132 unless distinguished. The brake drivers 123a and 123b are drivers for the brake motors 133a and 133b disposed in the two crawler traveling bodies 11a and 11b, respectively. In the following description, the brake drivers 123a and 123b may be referred to collectively as brake driver(s) 123 unless distinguished, and the brake motors 133a and 133b may be referred to collectively as brake motor(s) 133 unless distinguished. The motor driver 122 and the brake driver 123 receive commands from the CPU 101 and control the traveling motor 132 and the brake motor 133, respectively.

The power button 12 is a switch for turning on or off the power of the traveling apparatus 1. The power button 12 operates in conjunction with the pressing of the power button 12 (see FIG. 1). The start button 13 is a switch for starting the two crawler traveling bodies 11a and 11b. The start button 13 operates in conjunction with the pressing of the start button 13 (see FIG. 1). The emergency stop button 14 is a switch for emergency stopping the two crawler traveling bodies 11a and 11b. The emergency stop button 14 operates in conjunction with the pressing of the emergency stop button 14 (see FIG. 1) described above.

The camera 151 includes an omnidirectional camera, a stereo camera, and an infrared camera. As described above, the distance measuring sensor 152 is an LRF or 2D-LiDAR sensor for horizontal detection. As described above, the distance measuring sensor 153 is an LRF or 3D-LiDAR sensor for oblique detection.

The satellite positioning system 154 receives radio waves from satellites and measures the position of the traveling apparatus 1 on the earth based on the reception result. The satellite positioning system 154 uses a real time kinematic global navigation satellite system (RTK-GNSS). In the position estimation by the RTK-GNSS, when a high-accuracy positioning solution (Fix solution) in the RTK-GNSS positioning is obtained, an accuracy of several centimeters can be obtained.

The satellite positioning system 154 includes two antennas 154a for GNSS reception (see FIG. 1). When there is a deviation of a certain length or more between positions of the position information obtained at the two antennas 154a, the satellite positioning system 154 determines that the reliability (i.e., accuracy) of the position information is low.

The IMU 155 includes a three-axis acceleration sensor and a rotational angular velocity sensor. The traveling apparatus 1 detects the inclination amount of the main body 10 of the traveling apparatus 1 using the measurement data of the IMU 155, and corrects the height difference with respect to the traveling road surface measured by the distance measuring sensor 153 based on the inclination amount of the traveling apparatus 1.

The IMU 155 is preferably disposed in the vicinity of the distance measuring sensor 153. In a case where the distance measuring sensor 153 is disposed on the main body 10 via an arm, the IMU 155 is preferably disposed on the arm. In the present embodiment, the IMU 155 also serves as an IMU for self-position estimation that estimates the posture of the traveling apparatus 1. Such a configuration can prevent the height position detected by the distance measuring sensor 153 from changing due to the main body 10 swinging back and forth during traveling on rough terrain.

A description is given below of a position restoration function of the imaging device 151a of the camera 151 during autonomous traveling of the traveling apparatus 1.

The camera 151 has the drive source (e.g., motor) 151c for driving the PT mechanism as described above. Accordingly, if a gear connected to the drive source (e.g., motor) 151c jumps due to vibration or impact during autonomous traveling, an imaging-direction deviation may occur with respect to a relative position (angle) from a home position (initial position) of the imaging device 151a. Such a deviation in the imaging direction is defined as a step-out. In the case of the step-out, a deviation occurs with respect to the stored position (angle) even if an instruction is issued to the camera 151 to face the preset position (angle).

The traveling apparatus 1 has a position restoration function of restoring the home position of the imaging device 151a of the camera 151 based on the step-out position. The position restoration function can be operated at any timing.

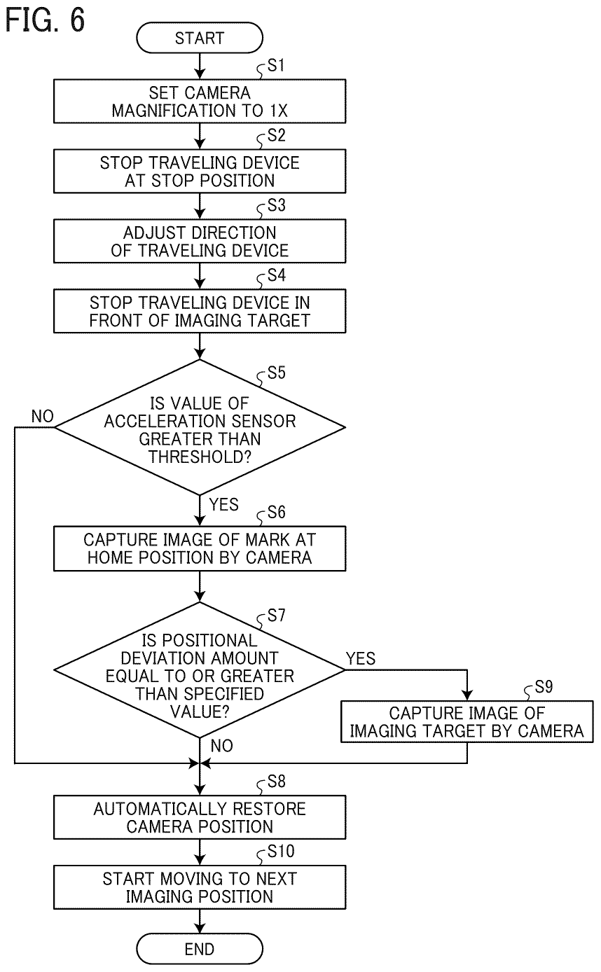

FIG. 6 is a flowchart of a position restoration process of the camera 151 during autonomous traveling by the traveling apparatus 1.

First, as illustrated in FIG. 6, in step S1, the deviation-amount detection unit 162 of the traveling apparatus 1 fixes the optical magnification of the camera 151 to 1× magnification during autonomous traveling. For example, in a case where the zoom is enlarged in the immediately preceding imaging, it may take physical time to move the optical zoom. For this reason, the optical magnification of the camera 151 during autonomous traveling is fixed to 1× magnification as described above.

The deviation-amount detection unit 162 of the traveling apparatus 1 starts an operation of stopping the traveling apparatus 1 at the stopping position from the autonomous traveling in step S2, adjusts the direction of the traveling apparatus 1 in step S3, and then completes the traveling stopping in front of an imaging target in step S4.

When the measurement value in the IMU 155 (acceleration sensor) does not exceed a predetermined threshold (No in step S5), the deviation-amount detection unit 162 of the traveling apparatus 1 proceeds to step S8.

On the other hand, when the measurement value in the IMU 155 (acceleration sensor) exceeds the predetermined threshold (Yes in step S5), the deviation-amount detection unit 162 of the traveling apparatus 1 determines that there is a possibility that the imaging-direction deviation occurs in the camera 151 due to vibration or impact, and captures an image of the home position by the camera 151 in step S6. When the detection of the amount of deviation is performed in this way only when there is vibration or impact, the operating time can be reduced.

In step S7, the deviation-amount detection unit 162 of the traveling apparatus 1 determines whether the amount of the imaging-direction deviation of the imaging device 151a of the camera 151 is equal to or greater than a specified value. The amount of imaging-direction deviation of the imaging device 151a of the camera 151 is reliably detected by comparing two captured images of the mark 201 of the marker 200 captured by the imaging device 151a of the camera 151. One is the captured image obtained by capturing the mark 201 of the marker 200 installed on a back surface (i.e., a surface on a side other than the front side, which is the front side in the traveling direction of the main body 10, the lateral sides, and the upper side) of the traveling apparatus 1, which is not used by the imaging device 151a during the autonomous traveling, by the imaging device 151a of the camera 151. The other is the captured image of the mark 201 at the home position, which is captured in advance by the imaging device 151a of the camera 151.

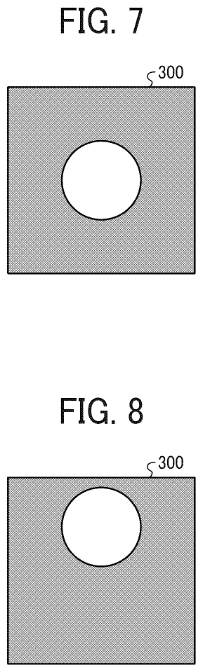

When the deviation-amount detection unit 162 of the traveling apparatus 1 determines that the amount of imaging-direction deviation of the imaging device 151a of the camera 151 is not equal to or greater than the specified value (No in step S7), the imaging device 151a captures an image of the imaging target in step S8 and the process proceeds to step S10. FIG. 7 is a diagram illustrating an example of an image in a case where the amount of imaging-direction deviation of the imaging device 151a of the camera 151 is not equal to or greater than the specified value. In the example illustrated in FIG. 7, the position of the mark 201 included in a captured image 300 of the marker 200 captured by the imaging device 151a is at the center position, and thus, a large positional deviation does not occur in the imaging direction of the imaging device 151a of the camera 151.

On the other hand, when the deviation-amount detection unit 162 of the traveling apparatus 1 determines that the amount of imaging-direction deviation of the imaging device 151a of the camera 151 is equal to or greater than the specified value (Yes in step S7), in step S9, the correction unit 163 corrects the imaging direction of the imaging device 151a with respect to the mark 201 by driving the drive source (e.g., motor) 151c based on the amount of imaging-direction deviation of the imaging device 151a of the camera 151, restores the home position, and proceeds to step S8. FIG. 8 is a diagram illustrating an example of an image in a case where the amount of imaging-direction deviation of the imaging device 151a of the camera 151 is equal to or greater than the specified value. In the example illustrated in FIG. 8, the position of the mark 201 included in a captured image 300 of the marker 200 captured by the imaging device 151a deviates from the center position, and a large positional deviation occurs in the imaging direction of the imaging device 151a of the camera 151.

When the above-described process ends, in step S10, the traveling apparatus 1 starts moving to the imaging location where the next imaging target is present.

As described above, the timing of detecting the amount of deviation in the imaging direction of the imaging device 151a is set to the period from when the traveling apparatus 1 (e.g., the mover 100) stops to when the imaging device 151a captures an image of the next imaging target. Thus, the time until the mark 201 is read can be shortened, and reliable detection can be ensured when the traveling apparatus 1 (e.g., the mover 100) is stopped.

The above-described configuration can adjust the imaging-direction deviation of the imaging device mounted on the mover with a simple configuration.

The traveling apparatus 1 may execute the position restoration process of the imaging device 151a of the camera 151 even when the mark 201 cannot be read due to a condition such as a shortage of light quantity in the imaging device 151a of the camera 151.

In the above description, the traveling apparatus 1 does not perform the imaging of the mark 201 again by the imaging device 151a of the camera 151 after the execution of the position restoration process. However, the process is not limited thereto, and the reliability of the correction may be ensured by capturing an image of the mark 201 again by the imaging device 151a of the camera 151.

The traveling apparatus 1 may also be configured to be able to switch whether it is necessary to confirm the imaging-direction deviation of the imaging device 151a of the camera 151 in the registration of the imaging location where the imaging target is present when setting the route of the autonomous traveling.

The traveling apparatus 1 may also be configured to allow a selection not to perform a series of steps of the position restoration process (from capturing of the mark 201 to restoration of the position) before the start of autonomous traveling.

For example, whenever vibration of movement is severe, the traveling apparatus 1 may be set to execute the position restoration process before imaging of the imaging target.

In the above description, the deviation-amount detection unit 162 of the traveling apparatus 1 performs determination according to the measurement value in the IMU 155 (acceleration sensor). However, such determination according to the measurement value in the IMU 155 (acceleration sensor) may not be necessarily performed. The deviation-amount detection unit 162 of the traveling apparatus 1 may capture an image of the home position by the camera 151 regardless of the measurement value in the IMU 155 (acceleration sensor).

A description is given below of some aspects of the present disclosure.

### FIRST ASPECT

A traveling apparatus includes: a mover including a crawler traveling body to rotate a crawler to autonomously travel; an imaging device above the mover and has a variable imaging direction; a driving source in the imaging device to move the imaging direction; a marker having a mark for aligning a position of the imaging device; a preset-position storage unit to store, as a preset position, an angle of the imaging device adjusted so that the mark included in a captured image of the marker captured by the imaging device is placed at a center; a deviation-amount detection unit to detect a position of the mark included in a captured image of the marker captured by the imaging device during autonomous traveling, calculates a deviation of the detected position of the mark from a center position, and detects a deviation amount of the imaging direction of the imaging device with respect to the preset position; and a correction unit to correct the imaging direction of the imaging device with respect to the mark, by driving the driving source, based on the deviation amount of the imaging direction of the imaging device detected by the deviation-amount detection unit.

### SECOND ASPECT

In the traveling apparatus according to the first aspect, the deviation-amount detection unit sets a timing of detecting the deviation amount of the imaging direction of the imaging device to a period from when the mover stops to when the imaging device captures an image of a next imaging target.

### THIRD ASPECT

In the traveling apparatus according to the first or second aspect, the deviation-amount detection unit sets an optical zoom of the imaging device to a predetermined magnification during movement of the mover when detecting the deviation amount of the imaging direction of the imaging device.

### FOURTH ASPECT

In the traveling apparatus according to any one of the first to third aspects, the marker is disposed on a side that is not used for the imaging device that captures an image during autonomous traveling.

### FIFTH ASPECT

The traveling apparatus according to any one of the first to fourth aspects includes a transparent hemispherical dome covering the imaging device. The marker is disposed in the dome. The mark has a round shape. The marker includes a base of a black tone color and the mark of a white tone color.

### SIXTH ASPECT

In the traveling apparatus according to any one of the first to fifth aspects, the marker is installed to be positioned at a center of the captured image captured using the imaging device by the preset-position storage unit.

### SEVENTH ASPECT

The traveling apparatus according to any one of the first to sixth aspects includes an acceleration sensor that is disposed in the mover and measures an acceleration of the mover. The deviation-amount detection unit captures an image of the mark when a measurement value in the acceleration sensor exceeds a predetermined threshold.

### EIGHTH ASPECT

A program for causing a computer to control a traveling apparatus that includes: a mover including a crawler traveling body to rotate a crawler to autonomously travel; an imaging device above the mover and has a variable imaging direction; a driving source in the imaging device to move the imaging direction; and a marker having a mark for aligning a position of the imaging device. The program for causing the computer to function as: a preset-position storage unit to store, as a preset position, an angle of the imaging device adjusted so that the mark included in a captured image of the marker captured by the imaging device is placed at a center; a deviation-amount detection unit to detect a position of the mark included in a captured image of the marker captured by the imaging device during autonomous traveling, calculates a deviation of the detected position of the mark from a center position, and detects a deviation amount of the imaging direction of the imaging device with respect to the preset position; and a correction unit to correct the imaging direction of the imaging device with respect to the mark, by driving the driving source, based on the deviation amount of the imaging direction of the imaging device detected by the deviation-amount detection unit.

### NINTH ASPECT

A method of controlling a traveling apparatus that includes: a mover including a crawler traveling body to rotate a crawler to autonomously travel; an imaging device above the mover and has a variable imaging direction; a driving source in the imaging device to move the imaging direction; and a marker having a mark for aligning a position of the imaging device. The method includes: a preset-position storage step of storing, as a preset position, an angle of the imaging device adjusted so that the mark included in a captured image of the marker captured by the imaging device is placed at a center; a deviation-amount detection step of detecting a position of the mark included in a captured image of the marker captured by the imaging device during autonomous traveling, calculates a deviation of the detected position of the mark from a center position, and detects a deviation amount of the imaging direction of the imaging device with respect to the preset position; and a correction step of correcting the imaging direction of the imaging device with respect to the mark, by driving the driving source, based on the deviation amount of the imaging direction of the imaging device detected by the deviation-amount detection step.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A traveling apparatus, comprising:
a mover including a crawler traveling body to rotate a crawler to autonomously travel;
an imaging device above the mover;
a drive source in the imaging device to move an imaging direction of the imaging device;
a marker including an alignment mark for aligning a position of the imaging device; and
processing circuitry configured to:
store, as a preset position, an angle of the imaging device adjusted so that the alignment mark included in a captured image of the marker captured by the imaging device is placed at a center of the captured image;
detect a position of the alignment mark included in another captured image of the marker captured by the imaging device during autonomous traveling;
calculate a deviation of the detected position of the alignment mark from a center position of said another captured image to detect a deviation amount of the imaging direction of the imaging device with respect to the preset position; and
drive the drive source based on the deviation amount of the imaging direction of the imaging device to correct the imaging direction of the imaging device with respect to the alignment mark.

2. The traveling apparatus according to claim 1,
wherein the processing circuitry is configured to set a timing of detecting the deviation amount of the imaging direction of the imaging device to a period from when the mover stops to when the imaging device captures an image of a next imaging target.

3. The traveling apparatus according to claim 1,
wherein the processing circuitry is configured to set an optical zoom of the imaging device to a predetermined magnification during movement of the mover, when the processing circuitry detects the deviation amount of the imaging direction of the imaging device.

4. The traveling apparatus according to claim 1,
wherein the marker is at a side not used for the imaging device to capture an image during autonomous traveling.

5. The traveling apparatus according to claim 1, further comprising a transparent hemispherical dome covering the imaging device,
wherein the marker is disposed in the dome, the alignment mark has a round shape, and
the marker includes a base of a black tone color of and the alignment mark of a white toner color.

6. The traveling apparatus according to claim 1,
wherein the processing circuitry is configured to set the marker to be positioned at a center of the captured image captured by the imaging device.

7. The traveling apparatus according to claim 1, further comprising an acceleration sensor in the mover to measure an acceleration of the mover,
wherein the processing circuitry is configured to capture an image of the alignment mark when a measurement value of the acceleration sensor exceeds a threshold.

8. A method of controlling a traveling apparatus, the method comprising:
adjusting an angle of an imaging device of the traveling apparatus so that, in a captured image of a marker of the traveling apparatus captured by the imaging device, an alignment mark of the marker is positioned at a center of the captured image;
storing, as a preset position, the angle of the imaging device;
detecting a position of the alignment mark included in another captured image of the marker captured by the imaging device during autonomous traveling of the traveling apparatus;
calculating a deviation of the detected position of the alignment mark from a center position of said another captured image to detect a deviation amount of an imaging direction of the imaging device with respect to the preset position; and
driving a drive source of the traveling apparatus based on the deviation amount of the imaging direction of the imaging device to correct the imaging direction of the imaging device with respect to the alignment mark.

9. A non-transitory recording medium storing computer-readable instructions which, when executed by one or more processors, cause the one or more processors to perform a process of controlling a traveling apparatus, the process comprising:
adjusting an angle of an imaging device of the traveling apparatus so that, in a captured image of a marker of the traveling apparatus captured by the imaging device, an alignment mark of the marker is positioned at a center of the captured image;
storing, as a preset position, the angle of the imaging device;
detecting a position of the alignment mark included in another captured image of the marker captured by the imaging device during autonomous traveling of the traveling apparatus;
calculating a deviation of the detected position of the alignment mark from a center position of said another captured image to detect a deviation amount of an imaging direction of the imaging device with respect to the preset position; and
driving a drive source of the traveling apparatus based on the deviation amount of the imaging direction of the imaging device to correct the imaging direction of the imaging device with respect to the alignment mark.
